(19) United States
(12) Patent Application Publication
(10) Pub. No.: US 2014/0362082 A1
(43) Pub. Date: Dec. 11, 2014

(54) Automated Overpass Extraction from Aerial Imagery

(71) Applicants: Joshua SCHPOK, Milpitas, CA (US); Tilman Reinhardt, Woodside, CA (US)

(72) Inventors: Joshua SCHPOK, Milpitas, CA (US); Tilman Reinhardt, Woodside, CA (US)

(73) Assignee: Google Inc., Mountain View, CA (US)

(21) Appl. No.: 13/100,225

(22) Filed: May 3, 2011

(51) Int. Cl. G06T 15/20

(52) U.S. Cl. 345/427

(57) ABSTRACT

A computer implemented system and method is disclosed for generating realistic three-dimensional models of roadway overpass structures. An example system comprises a segmentation module configured to identify roadway overpass regions, based on existing map data containing locations of roadway intersections, aerial imagery, and a digital surface model (DSM). A roadway overpass region is assumed to have at least a first and second road segment. A DSM provides an elevation z for each two-dimensional point (x, y). The segmentation module identifies the upper and lower roadway sections of an overpass structure and an extraction module generates a three-dimensional model of the overpass based on the segmented regions identified by the segmentation module. The extraction module combines aerial images with 3D computer models of overpass structures to generate a realistic 3D rendering of surface topography of the earth including roadway overpass structures.

### BACKGROUND

1. Field

This disclosure relates to systems and methods for combining satellite and aerial imagery with map data and digital surface models for realistic 3D computer simulations and rendering of the topography of the earth's surface including local surface features.

2. Background Art

The field of aerial imagery is concerned with capturing photographs of land masses over large areas. In aerial imagery, one distinguishes between nadir images and oblique images. Nadir=images are photographed using a camera that faces straight down whereas oblique images are generated using cameras that are oriented at an angle to the ground. Aerial photographs are often combined. For example, a panoramic image can be made by stitching several photographs together. Large sets of aerial or satellite photographs can be combined and used in online map systems.

Aerial photos and satellite images, however, do not generally show features in their correct locations due to distortions caused by the tilt of the camera and/or the non-uniform terrain of the earth's surface. In other words, when a large collection of aerial photographs or satellite images are stitched together to create a map, the resulting composite image is distorted. Thus, in general, a composite image created by stitching together many images of the ground does not represent scale appropriately. The scale of the composite image is, in general not constant, and accurate measurements of distance and direction cannot be made.

A technique known as orthorectification is often used to correct aerial and satellite images for distortions. Orthorectification transforms the central projection of the photograph so as to more closely approximate an orthogonal view (i.e., one looking straight down). The orthorectification process substantially removes the distorting effects of tilt and terrain relief. The result of the orthorectification process is often called an orthoimage or an orthophoto.

Orthophotos or orthoimages are often used in the field of geographic information systems (GIS). A geographic information system or geospatial information system is any system that presents data specifically associated with spatial locations. An example of a GIS is a system that correlates aerial or satellite images with maps.

As mentioned above, aerial photographs are useful for providing spatial information, but they often contain geometric distortions. Orthorectification is the process of using a mathematical model that takes a digital elevation model (DEM) as input to correct distortions in aerial photographs and satellite images. A DEM is defined by specifying an elevation z for each point (x, y) as z=DEM(x, y). The process of orthorectification is a pixel-by-pixel correction of the scale and relief of an image that typically results from variations in distance between a camera acquiring images (often flown on an aircraft over an area of interest) and the surface topography of the ground.

A technique called “bundle-block adjustment” is an algorithm that can be used to stitch together a large collection of images to create a composite image that has the scale appropriately corrected using the orthorectification process. The algorithm involves a large set of interrelated equations that are used to find a globally optimum set of corrections across a composite image.

An input to the orthorectification process is a DEM, which is given as a collection of elevation values represented by the coordinate z as a function of the two-dimensional coordinates (x, y). Such a model is typically specified in terms of the value of the elevation at each point (x, y) in a rectangular grid of tiles. A DEM is typically built using remote sensing techniques. A DEM can also be built by land surveys. One source of DEM data is the U.S. Geological Survey (USGS).

One problem with the conventional orthorectification process is that it does not properly take into account objects such as buildings, bridges, trees, etc. Such objects often appear distorted from their true positions and shapes in the resulting orthophotos. For example, buildings often appear to be leaning and bridges may appear to be bent or warped. Currently, there is a need for computer enabled systems and methods to correct artifacts.

### BRIEF SUMMARY

A computer implemented system and method is disclosed for generating realistic three-dimensional models of roadway overpass structures. An example system comprises a segmentation module configured to identify roadway overpass regions, based on existing map data containing locations of roadway intersections, aerial imagery, and a digital surface model (DSM). A roadway overpass region is assumed to have at least first and second road segments. A DSM provides an elevation z for each two-dimensional point (x, y), as z=DSM(x, y). The segmentation module identifies the upper and lower roadway sections of an overpass structure and an extraction module generates a three-dimensional model of the overpass based on the segmented regions identified by the segmentation module. The extraction module combines aerial images with 3D computer models of overpass structures to generate a realistic 3D rendering of surface topography of the earth including roadway overpass structures.

Further features and advantages, as well as the structure and operation of various embodiments are described in detail below, with reference to the accompanying drawings. It is noted that the invention is not limited to the specific embodiments described herein. Such embodiments are presented herein for illustrative purposes only. Additional embodiments will be apparent to persons skilled in the relevant art(s), based on the teachings contained herein.

### BRIEF DESCRIPTION OF THE DRAWINGS/FIGURES

The accompanying drawings which are incorporated herein and form a part of the specification, illustrate the present invention and together with the description, further serve to explain the principles of the invention, and to enable a person skilled in the pertinent art(s) to make and use the invention.

FIG. 1A is an aerial photograph that has been altered by orthorectification showing an artifact of a bent overpass bridge structure.

FIG. 1B shows a corrected structure according to an embodiment of the invention.

FIG. 2 illustrates an exemplary system comprising a segmentation module and an extraction module, whereby roadway map data is combined with a digital surface model (DSM) and aerial images to produce a realistic 3D model of a roadway overpass structure.

FIG. 3 is a schematic illustration of a method whereby map data is combined with aerial images and a DSM to produce a realistic 3D model of roadway overpass structures.

FIG. 4 is an aerial image of a roadway overpass structure and a model that has been superimposed over it.

FIG. 5 is an aerial image of a collection of roadway overpass structures that have been corrected according to the embodiments of this invention.

FIGS. 6A and 6B illustrate model overpass structures that have been superimposed on aerial images.

### DETAILED DESCRIPTION OF EMBODIMENTS

This disclosure is directed to systems and methods for generating realistic three-dimensional models of roadway overpass structures by combining aerial images with a DSM. It is noted that reference in the specification to “one embodiment,” “an embodiment,” “an example embodiment,” etc., indicate that the embodiment described may include a particular feature, structure or characteristic, but not every embodiment may necessarily include the particular feature, structure or characteristic. Moreover, such phrases are not necessarily referring to the same embodiment. Further, when a particular feature, structure or characteristic is described in connection with an embodiment, it is submitted that it is within the knowledge of one skilled in the art to effect such structure, feature or characteristic in connection with other embodiments, whether or not explicitly described. Embodiments will be described with reference to the accompanying figures.

This disclosure is concerned with the process of simulating 3D landscapes by combining satellite imagery and aerial photography with a digital surface model (DSM). The systems and methods overcome problems that cannot be addressed by existing technology, in particular, distortions of roadway overpass structures arising from orthorectification of aerial and satellite images.

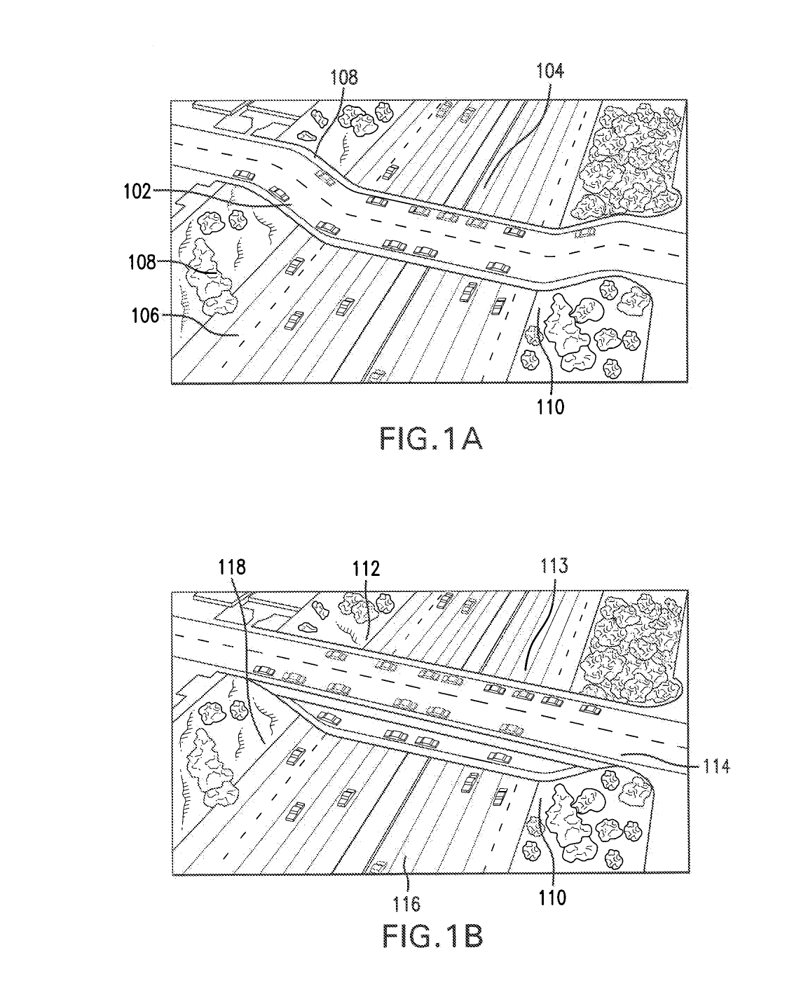

As discussed above, conventional orthorectification algorithms correct image distortions in scale arising due to variations in surface topography and the tilt angle of cameras or sensors that acquire images. The conventional orthorectification utilizes a digital elevation model (DEM) that describes surface features of the ground. Standard DEMs (such as those obtained by the USGS) do not take into account local surface variations in elevation caused by bridges, buildings, trees, etc. Thus, such objects appear distorted in the resulting orthophotos, giving rise to artifacts. These artifacts may include, for example, buildings that appear to lean and bridges that appear to be warped or bent. FIG. 1A is an example of such an artifact in which a bridge overpass structure appears to be flattened due to the orthorectification process. This is directly related to the fact that the conventional DEMs only account for variations in elevation of the ground without the local features. An example of a corrected image is shown in FIG. 1B which exhibits a level bridge surface 112 and 113.

The disclosed systems and methods correct these problems by using a DSM that accounts for local surface elevations including those associated with buildings, bridges, trees, etc. Such a DSM is generated by analyzing a large collection of aerial images wherein each area in question is photographed from multiple angles and each image is encoded with data describing the position, velocity, attitude, and altitude of the camera or cameras acquiring the images. Images are also encoded with a timestamp. Such data encoding also allows the multiple images to be assembled into a composite image or “synthetic frame” of a large land mass using the “bundle block adjustment” procedure.

The problem of generating realistic 3D models of overpass structures is solved by a two-step process that combines aerial images with roadway map data and the DSM. The two steps are “segmentation” and “extraction.” In the segmentation stage, overpass regions are identified using data from an existing database of roadway intersections. Using the roadway map data, all the intersections can be identified and correlated with digital images. Each intersection is a candidate overpass region. When two roads meet, they either intersect or there exists an overpass.

Online map systems use roadway map databases in which roadway intersections are explicitly stored for routing directions. Such data, in which a vector road network can be aligned with aerial imagery, is often called “vector road data.” If two roads are observed to cross, but no intersection feature exists, it may be assumed that these two roads cross over each other. Furthermore, the stacking order of overpassing roads is often represented using a numerical stacking index. It may be assumed that any road segments with this property participate in an overpass structure (either as the overpass, or the overpassed). The upper road segment(s) is/are considered as the segmentation of the overpass.

Each overpass is assumed to have constant width. The elevation of a candidate overpass structure is analyzed in terms of its elevation in a direction perpendicular to the direction of the roadway segment. The edge of an overpass structure is defined by a steep drop in elevation z as a function of distance perpendicular to the direction of the roadway. The width of an overpass can be determined as the distance between two steep drop-offs on either side of a candidate overpass structure. This provides an overpass span width measurement and a corrected road midpoint per vertex. Though overpasses are assumed to be constant width, multiple span widths are sampled because the DSM may be noisy and may contain elements overlaying the overpass (other overpasses or trees). Outlying widths are omitted and the overpass width is approximated by the average of the remaining widths. The initial vector road data is updated to the new calculated midpoint.

Overpasses are assumed not to roll. This is inaccurate for banked roads, but this is a compromise to avoid noisy elevations. The DSM is sampled along the corrected midpoints to compute the overpass elevation. The DSM is smoothed to reduce high-frequency noise.

By finding the edges of the upper road segment of an overpass, the overpass structure is said to be “segmented.” The two or more segments give the upper and lower roadways of the overpass structure. A 3D model of the roadway overpass structure can then be generated given the description of the overpass structure in terms of a collection of (x, y, z) coordinates resulting from the segmentation process.

In the extraction step, the segmented regions of the overpass structure are converted into a 3D geometric model which is then superimposed on the corresponding aerial imagery to produce a realistic 3D model of the roadway overpass structure.

Thus for the combined segmentation and extraction steps there are three required pieces of information: (1) aerial imagery, including images of the ground involving roads and roadway intersections, (2) a DSM giving all local elevation variations, and (3) roadway map data that provides information regarding the location of roadway intersections.

During the segmentation step, the elevation z of a candidate overpass structure is sampled within a specific bounding region that is specified in terms of a collection of tiles forming a rectangular grid.

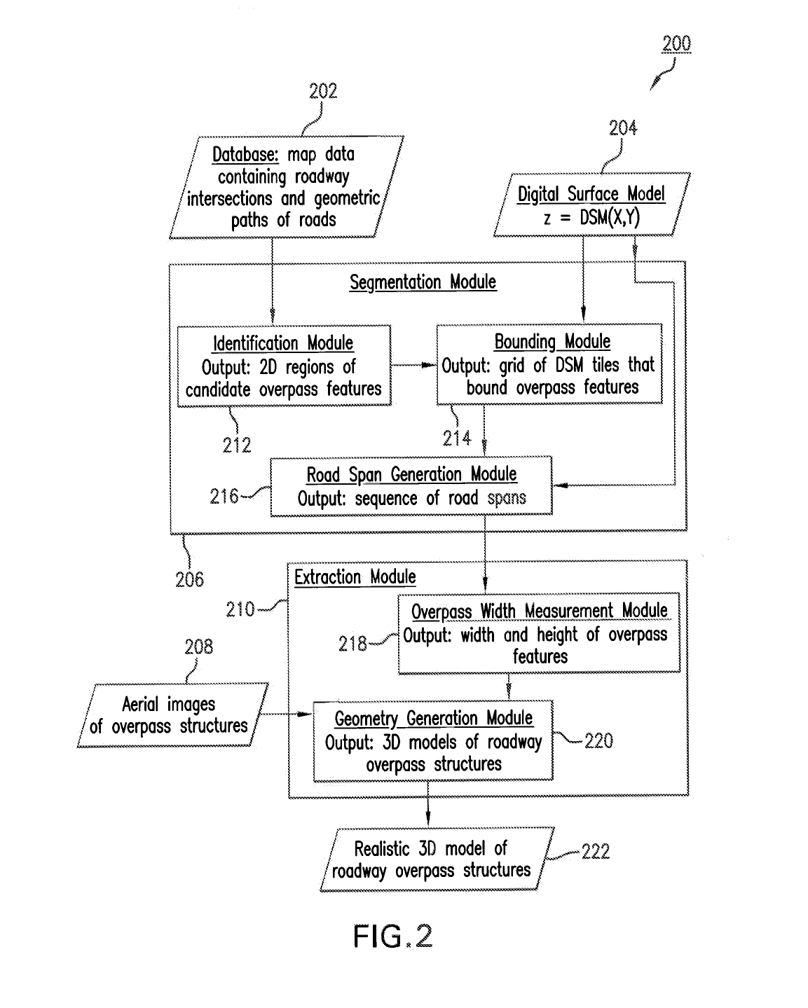

FIG. 2 illustrates a system for carrying out the process of generating realistic 3D models of overpass structures using roadway map data, a digital surface model, and a collection of aerial images. The system is comprised of a segmentation module 206, and an extraction module 210. The segmentation module 206 also further comprises an identification module 212 that takes map data of roadway intersections 202 from a database. The identification module searches the database of map data and identifies 2D regions of candidate overpass features. Such features are areas where two or more roadways cross one another. Wherever a roadway crosses, it must be one of two situations: it's either an intersection or an overpass. Thus, by identifying where roadways cross, one determines a collection of candidate overpass features.

The segmentation module also comprises a bounding module 214. The bounding module 214 takes two inputs: (1) the collection of overpass features from the identification module 212 and (2) input from the digital surface model 204. The bounding module 214 operates to determine a bounding region for an overpass structure. The data that it obtains from the identification module 212 is comprised of a collection of tiles (i.e. 2D regions on which the DSM is defined). The collection of tiles gives the bounds on where the candidate overpass feature may exist.

The bounding module considers a roadway segment that is identified as a candidate overpass structure by the identification module 212 and determines a boundary legion. Given this bounded region, the road span generation module 216 generates a 3D computer model comprising a sequence of road spans. This sequence of road spans is fed to the extraction module 210.

The process of identifying the width of the overpass is carried out using the overpass width measurement module 218. This module 218 samples the DSM in a direction perpendicular to the roadway segment and searches for (x, y) points at which the elevation z changes dramatically indicating the edge of an upper segment of an overpass structure. Once two such features are found, the width can be defined as the distance between the two edges having a sharp drop-off in elevation.

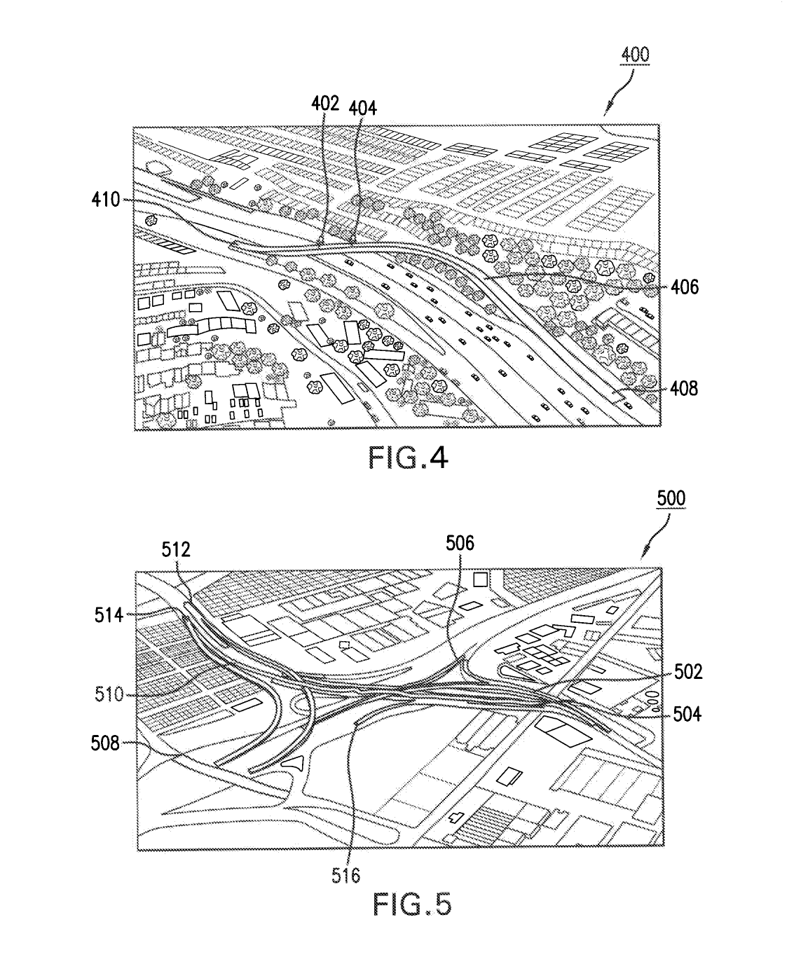

The geometry generation module 220 generates a 3D model of a roadway overpass structure taking input from a collection of aerial images of overpass structures 208 and combining these with width measurements from 218 to generate a 3D model of a roadway overpass structure. The result is a 3D model of a roadway overpass structure as illustrated in FIG. 4.

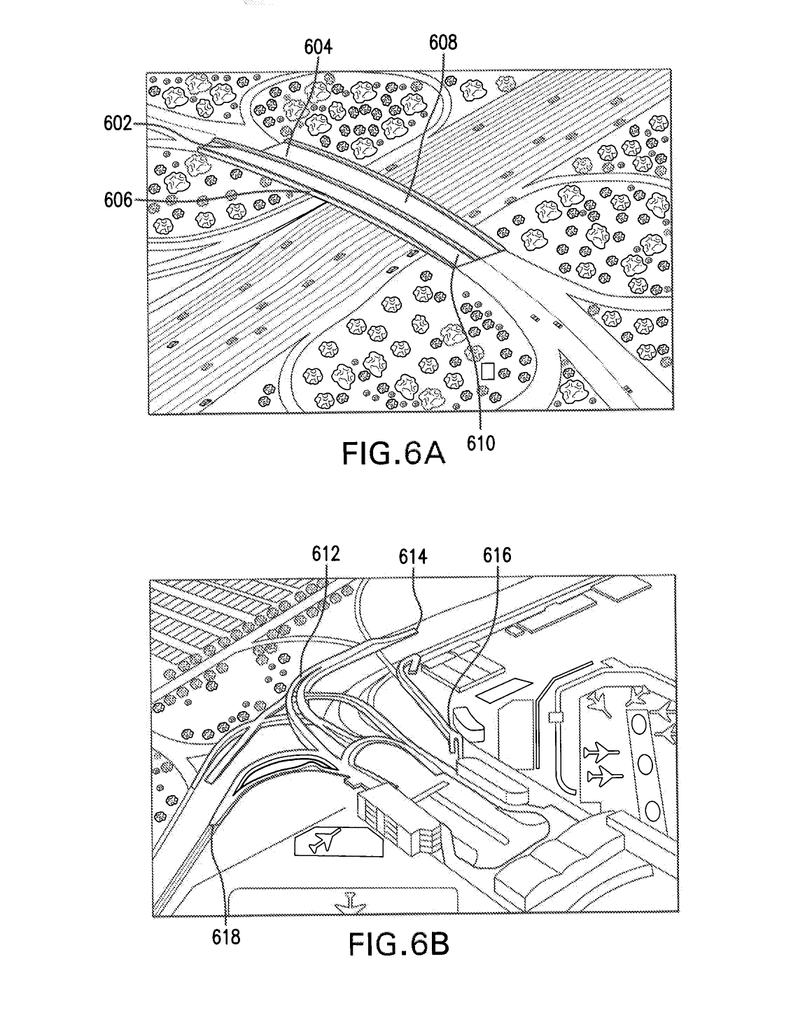

FIG. 4 illustrates the result of using the system of FIG. 2. Two roadway candidate overpass structures are illustrated by 402 and 404; these are regions where one road crosses another road. As can be seen from this figure, it's not a simple overpass structure as illustrated in FIG. 1 where two roads intersect at right angles. This is a more complicated intersection where multiple roadway regions cross. The geometric model of the overpass is illustrated by the continuous curve that spans from 408 to 406 to 410. More example 3D models obtained by using this system and method are illustrated in FIGS. 5 and 6, and will be discussed in the following.

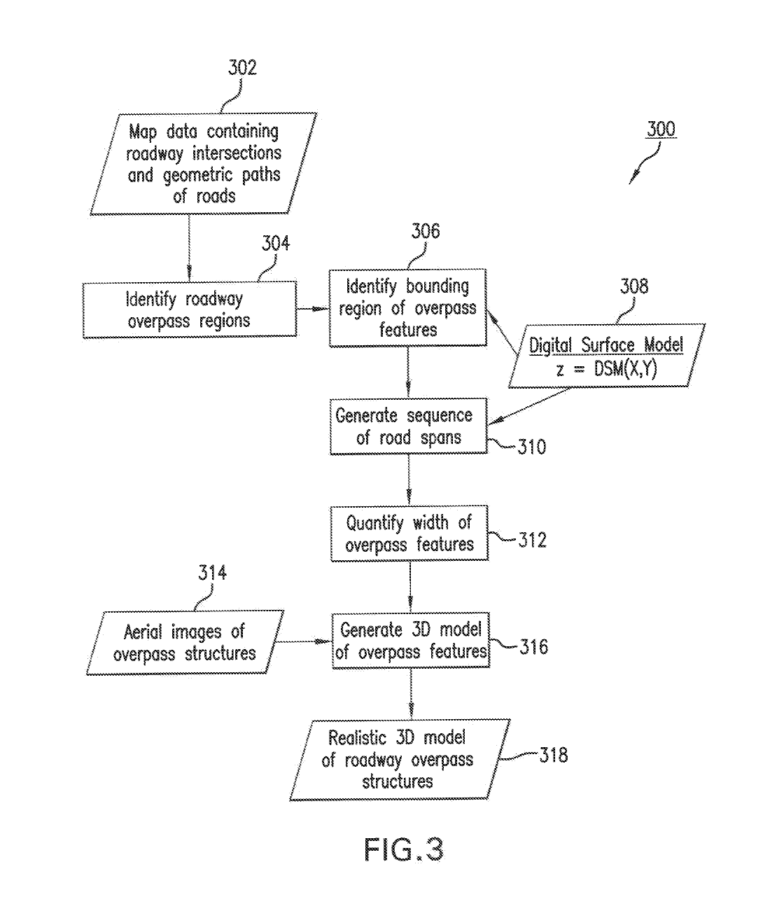

FIG. 3 illustrates a general method whereby 3D realistic models of overpass structures can be generated. One of the starting inputs 302 is a database of map data of roadway intersections. This data comprises points at which one or more roads cross one another as well as geometric paths of road segments. The first step 304 is to identify places where roads intersect one another. As illustrated in FIG. 1A, one can see that the road 102 crosses over another road 106. Another example is shown in FIG. 4, at the two points 402 and 404 where the upper road crosses the lower road.

Next, a candidate overpass region 306 is identified using the DSM 308. Once the overpass regions are identified, it is possible to generate a sequence of road spans 310. Next the width of a candidate overpass region is quantified 312 by searching the elevation value z in directions perpendicular to the roadway segment to find precipitous changes in elevation z that identify the edges of overpass regions. Next, a 3D model of the overpass structure is generated 318. This model combines aerial images 314 with a geometric model 316 to produce a realistic model of roadway overpasses 318. Such a model is illustrated in FIG. 4 as the span between 408, 406 and 410. Examples of such realistic 3D models combined with aerial images are shown in FIGS. 5 and 6.

FIG. 5 shows another example result obtained by using the system and method disclosed here. This image shows a complicated collection of bridges and overpasses illustrated by 502 through 516. A termination of a geometric model of an overpass is illustrated in 508. Similar examples of the termination of overpass models are shown in 506, 512, 514 and 516. The system and method are capable of resolving complicated features such as the closely spaced parallel road segments of overpass features 502, 504, and 510.

FIGS. 6A and 6B show more examples of complicated features that can be extracted using the system and method disclosed herein. FIG. 6A shows two closely spaced parallel overpass road segments. The segment between 602 and 610 is nearly touching the segment between 604 and 608. The edge of the overpass 606 is also clearly resolved. As illustrated here, the system and method are robust to complicated structures wherein multiple roadways cross one another as shown in FIG. 6B. Label 612 illustrates multiple roadways passing across one another.

FIG. 4 shows a situation in which the overpass is terminated smoothly in features 408 and 410. As discussed previously, the edge of an overpass is determined by the precipitous drop of the DSM on either side of the overpass. As the system and method sample the edges of overpass, along the roadway segment, the magnitude of the precipitous drop decreases until one reaches the edge of the overpass where it connects back with the roadway (see terminating regions 408 and 410 in FIG. 4). Thus, the system and method must be tuned such that they can identify a smooth ending for the overpass structure. The system and methods are fully automated and as such, have criteria for determining a smooth termination of an overpass structure. Such tuning has been demonstrated for disclosed embodiments as illustrated in FIG. 4 and can be implemented by one of ordinary skill in the art without undue experimentation.

### CONCLUSION

The summary and abstract sections may set forth one or more, but not all exemplary embodiments of the present invention as contemplated by the inventors, and, are thus not intended to limit the present invention and appended claims in any way.

Various embodiments have been described above with the aid of functional building blocks illustrating the implementation of specific features and relationships thereof. The boundaries of these functional building blocks have been arbitrarily defined herein for the convenience of the description. Alternate boundaries can be defined so long as specific functions and relationships thereof are appropriately performed. The foregoing description of these specific embodiments will so fully reveal the general nature of the invention that others can apply knowledge of those skilled in the art, readily modify and/or adapt for various applications, such as specific embodiments without undue experimentation, without departing from the general concept of the present invention. Therefore, such adaptations and modifications are intended to be within the meaning and range of equivalents of the disclosed embodiments based on the teachings and guidance presented herein. It is to be understood that the phraseology or terminology herein is for the purpose of description and not limitation such that the terminology and phraseology of the present specification is to be interpreted by those skilled in the art(s) in light of the teachings and guidance disclosed herein.

The breadth and scope of the present invention should not be limited to any of the above-described exemplary embodiments.

1. A computer implemented system for generating realistic three-dimensional models of roadway overpass structures comprising:
at least one processor;
a segmentation module configured to he executed on the at least one processor and that identifies a roadway overpass regions having first and second road segments based at least in pan on map data containing a locations of a roadway intersections comprising the first and second road segments and a digital surface model (DSM) providing an elevation z for each two-dimensional point (x, y), wherein the segmentation module is further configured to identify a segmented region of an overpass from the first and second road segments; and
an extraction module configured to be executed on the at least one processor and that generates a three-dimensional model of the overpass based on the segmented regions identified by the segmentation module.

2. The system of claim 1, wherein the first and second road segments are upper and lower segments of the overpass, respectively.

3. The system of claim 1, wherein the segmentation module further comprises:
(c) an identification module configured to identify all road segments that may potentially be part of an overpass region, based on information related to a collection of roadway intersections stored in a database;
(d) a spatial bounding module configured to identify a two-dimensional hounding region for each candidate overpass feature, determined by the identification module, wherein the bounding region is specified in terms of elements of a two-dimensional grid of tiles that are used to specify the DSM; and
(e) an overpass width measurement module configured to quantify the width of each candidate overpass feature by sampling elevations given by the DSM, within each given bounding region, in a direction perpendicular to each road segment to identify positions at which the DSM exhibits a precipitous drop indicating an edge of an overpass.

4. The system of claim 3, wherein the extraction module further comprises:
(f) a road span generation module configured to generate, from an overpass's width and elevation profile, determined by the segmentation module, a sequence of road spans, wherein each span is assumed to be level across a given span; and
(g) a geometry generation module configured to generate a three-dimensional rendering of an overpass structure by combining the sequence of road spans, generated by the road span generation module, with aerial imagery of the overpass and surrounding regions.

5. A computer implemented method for generating realistic three-dimensional models of roadway overpass structures comprising:
(a) identifying, by one or more computing devices, roadway overpass regions having first and second road segments using a segmentation module based at least in part on map data containing a locations of a roadway intersections comprising the first and second road segments and a digital surface model (DSM) providing an elevation z for each two-dimensional point (x, y), wherein the segmentation module is further configured to identify a segmented region of an overpass from the first and second road segments, the one or more computing devices comprising one or more processors; and
(b) generating, by the one or more computing devices, a three-dimensional model of the overpass with an extraction module based on the segmented regions identified by the segmentation module.

6. The method of claim 5, wherein the first and second road segments are upper and lower segments of the overpass, respectively.

7. The method of claim 5, further comprising
(c) identifying, using an identification module, all road segments that may potentially be part of an overpass, based on information related to a collection of roadway intersections stored in a database;
(d) identifying, using a spatial bounding module, a two-dimensional bounding region for each candidate overpass feature, determined by using the identification module, wherein the bounding region is specified in terms of elements of a two-dimensional grid of tiles that are used to specify the DSM; and
(e) sampling elevations given by the DSM, within each given bounding region, using an overpass width measurement module, in a direction perpendicular to each road segment to quantify the width of each candidate overpass feature and identify positions at which the DSM exhibits a precipitous drop indicating an edge of an overpass.

8. The method of claim 7, further comprising:
(f) generating, using a road span generation module, from an overpass's width and elevation profile, determined by using a segmentation module, a sequence of road spans, wherein each span is assumed to be level across a given span; and
(g) generating, using a geometry generation module, a three-dimensional rendering of an overpass structure by combining the sequence of road spans, generated by using a road span generation module, with aerial imagery of the overpass and surrounding regions.

9. A non-transitory computer readable storage medium having instructions stored thereon that, when executed by a processor, cause the processor to perform operations including:
(a) identifying roadway overpass regions having first and second road segments using a segmentation module based at least in part on map data containing a locations of a roadway intersection comprising the first and second road segments and a digital surface model (DSM) providing an elevation a for each two-dimensional point (x, y), wherein the segmentation module is further configured to identify a segmented region of an overpass from the first and second road segments; and
(b) generating a three-dimensional model of the overpass with an extraction module based on the segmented regions identified by the segmentation module.

10. The computer readable storage medium of claim 9, wherein the first and second road segments are upper and lower segments of the overpass, respectively.

11. The computer readable storage medium of claim 9, having instructions stored thereon that, when executed by a processor, cause the processor to perform operations further including:
(c) identifying, using an identification module, all road segments that may potentially be part of an overpass, based on information related to a collection of roadway intersections stored in a database;
(d) identifying, using a spatial bounding module, a two-dimensional bounding region for each candidate overpass feature, determined by using the identification module, wherein the bounding region is specified in terms of elements of a two-dimensional grid of tiles that are used to specify the DSM; and
(e) sampling elevations given by the DSM, within each given bounding region, using an overpass width measurement module, in a direction perpendicular to each road segment to quantify the width of each candidate overpass feature and identify positions at which the DSM exhibits a precipitous drop indicating an edge of an overpass.

12. The computer readable storage medium of claim 11, having instructions stored thereon that, when executed by a processor, cause the processor to perform operations further including:
(f) generating, using a road span generation module, from an overpass's width and elevation profile, determined by using a segmentation module, a sequence of road spans, wherein each span is assumed to be level across a given span; and
(g) generating, using a geometry generation module, a three-dimensional rendering of an overpass structure by combining the sequence of road spans, generated by using a road span generation module, with aerial imagery of the overpass and surrounding regions.
